(19) United States
(12) Patent Application Publication
(10) Pub. No.: US 2009/0025271 A1
(43) Pub. Date: Jan. 29, 2009

(54) ILLUMINATED SUBMERSIBLE BAIT APPARATUS

(76) Inventor: Koby L. Duckworth, Buda, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/829,640

(22) Filed: Jul. 27, 2007

(51) Int. Cl. A01K 85/01; A01K 97/02

(52) U.S. Cl. 43/17.5; 43/44.99; 43/55

(57) ABSTRACT

A submersible bait apparatus is disclosed. The apparatus may include a submersible transparent container that holds live fishing bait. A light assembly may be coupled to the container. The light assembly may include one or more cordless, electrically powered light sources that provide a user selectable illumination color.

### BACKGROUND

1. Field of the Invention

The present invention relates to fishing equipment. More particularly, the invention relates to an apparatus used for underwater illumination of live fishing bait.

2. Description of Related Art

Developments within the sport of fishing are primarily concentrated on enticing fish into an area being fished and baiting the fish onto fishing line. Lights may be used to attract insects to a fishing area. Attracting insects with lights near or in water offers an abundant food source for fish because the insects may become trapped on the water's surface. The abundance of insects in the lighted area may lure bait fish and/or small game fish into the fishing area (the lighted area). Larger game fish may also be attracted to the light due to a higher concentration of bait fish or small game fish found in the lighted area. Any of the fish (bait fish, small game fish, or large game fish) may have a learned behavior to be attracted to the lighted area because an abundant food supply is most likely found near the lights.

Fish, however, may be reluctant to leave the security of cover (e.g., darkness) to exploit the opportunities provided by surface lights (e.g., the abundant food source). Additionally, a submersed light may also not provide the stimulus to lure game fish from hiding if there is no bait (e.g., bait fish) coming to or in the vicinity of the light. One solution to attract the reluctant fish is to provide illumination of captive bait fish in the heart of the secure game fish cover area. An apparatus that openly provides light stimulus and bait fish within a clear container may entice the game fish from hiding (e.g., from leaving their secure area). Once the game fish has been enticed by the bait within the lighted bait fish container, the game fish may be more likely to strike at other baits offered within the area. Thus, the chances for successful fishing may be increased by use of the lighted bait fish container.

### SUMMARY

In certain embodiments, a submersible bait apparatus includes a submersible transparent container that holds live fishing bait. A light assembly may be coupled to the container. The light assembly may include one or more cordless, electrically powered light sources that provide a user selectable illumination color. The light assembly may be removably coupled to the container.

In some embodiments, the light assembly may include a changeable lens assembly that provides a desired illumination color for the light sources. In some embodiments, the light assembly includes a changeable lens assembly that allows a user to select the desired illumination color for the light sources. In some embodiments, the light sources are powered by one or more batteries located in or attached to the container.

In some embodiments, the container traps live fishing bait while submerged. The container may inhibit the live fishing bait from escaping the container. The container may include one or more openings that allow water into the container while inhibiting live fishing bait from escaping the container. A lower portion of the container may include a water-tight construction to inhibit water from draining from the container when the container is removed from the water.

In certain embodiments, a submersible bait apparatus includes a submersible transparent container that holds live fishing bait. One or more cordless, electrically powered light sources may be coupled to the container. A changeable lens assembly may be coupled to the container. The lens assembly may provide a desired illumination color for the light sources. In some embodiments, the lens assembly is removable. In some embodiments, one or more audible stimulation devices are coupled to the apparatus.

### BRIEF DESCRIPTION OF THE DRAWINGS

Features and advantages of the methods and apparatus of the present invention will be more fully appreciated by reference to the following detailed description of presently preferred but nonetheless illustrative embodiments in accordance with the present invention when taken in conjunction with the accompanying drawings in which:

FIG. 1 depicts a representation of an embodiment of a submersible bait apparatus.

FIG. 2 depicts a front view representation of an embodiment of a bait container.

FIG. 3 depicts a sectional representation of an embodiment of a light assembly body.

FIG. 4 depicts a sectional representation of an embodiment of a light assembly body with o-rings shown.

FIG. 5 depicts a sectional representation of an embodiment of a light assembly body with a light mount.

FIG. 6 depicts a sectional representation of an embodiment of a light assembly body with a light mount and a battery holder.

FIG. 7 depicts a sectional representation of an embodiment of a light assembly body, a light mount, and a battery holder with lights coupled to the light mount.

FIG. 8 depicts a sectional representation of an embodiment of a light assembly body, a light mount, a battery holder, and lights with a cap coupled to the body.

FIG. 9 depicts a sectional representation of an embodiment of a light assembly body, a light mount, a battery holder, lights, and a cap with a lens cover coupled to the body.

While the invention is susceptible to various modifications and alternative forms, specific embodiments thereof are shown by way of example in the drawings and will herein be described in detail. The drawings may not be to scale. It should be understood that the drawings and detailed description thereto are not intended to limit the invention to the particular form disclosed, but to the contrary, the intention is to cover all modifications, equivalents and alternatives falling within the spirit and scope of the present invention as defined by the appended claims.

### DETAILED DESCRIPTION OF EMBODIMENTS

In the context of this patent, the term “coupled” means either a direct connection or an indirect connection (e.g., one or more intervening connections) between one or more objects or components. The phrase “directly connected” means a direct connection between objects or components such that the objects or components are connected directly to each other so that the objects or components operate in a “point of use” manner.

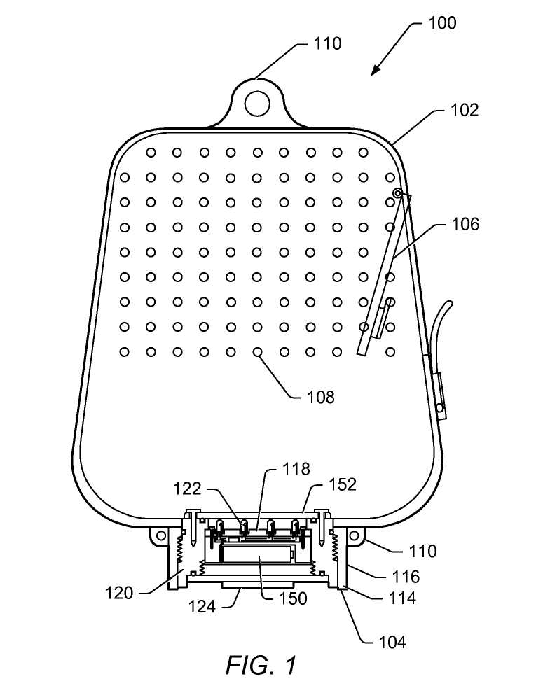

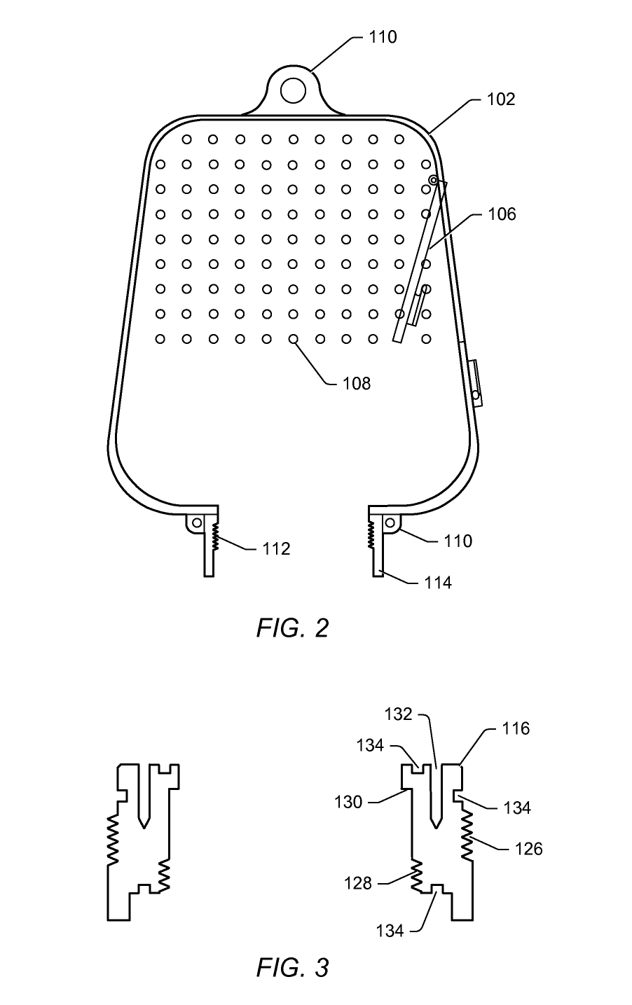

FIG. 1 depicts a representation of an embodiment of a submersible bait apparatus. In certain embodiments, apparatus 100 includes container 102 and light assembly 104. FIG. 2 depicts a front view representation of an embodiment of container 102. Container 102 may be made of lightweight, rigid materials such as plastic or acrylic. In certain embodiments, container 102 is made of injection molded plastic. Container 102 may be substantially transparent to visible light so that the interior contents of the container are visible from outside the container and vice versa. As shown in FIGS. 1 and 2, container 102 has a rectangular shape. It is to be understood, however, that apparatus 100 and container 102 may have any shape and/or configuration as is desired. For example, container 102 may have a circular or square shape.

Container 102 may hold live fishing bait within the container. In certain embodiments, container 102 may trap live fishing bait in the container when the container is submerged underwater. Bait fish may be lured by lighting container 102 or otherwise lured into the container. In some embodiments, bait fish are lured into container 102 through door 106. Door 106 is shown partially open in FIG. 2. After bait fish have been lured inside container 102, door 106 may be closed to trap the bait fish inside the container. Door 106 may be closed manually or automatically after bait fish have entered container 102. For example, a rope or cord may be attached to door 106 to allow a user to manually open and shut the door. In some embodiments, a bungee strap or other securing device may be used to keep door 106 closed when desired. The bungee strap may be permanently attached to container 102.

Bait fish inside container 102 may be inhibited from escaping the container with door 106 closed. Container 102 may include one or more holes 108 to allow water to flow into and out of the container. Holes 108 may be sized so that water can flow through the holes but bait fish cannot escape through the holes.

In certain embodiments, holes 108 allow water to escape (e.g., drain) from container 102 when the container is removed from the water. In certain embodiments, holes 108 are located so that at least some water remains in a lower portion of container 102 even after water drains from the container. For example, holes 108 may be located in an upper portion of container 102. In some embodiments, holes 108 are located above the bottom of door 106 on container 102, as shown in FIG. 2. Having some water remaining in container 102 allows the container to keep water on bait fish in the container when the container is not submerged in water. The lower portion of container 102 may have a water-tight construction to inhibit water leakage from the lower portion of the container. For example, the lower portion of container 102 may be of solid construction and/or include one or more water-tight seals.

In certain embodiments, coupling device 110 is attached to an upper portion of container 102. In some embodiments, coupling device 110 is a loop, hook, or other device for coupling a rope, a cord, or other attachment to container 102. In some embodiments, coupling device 110 is used to couple container 102 to a fixed structure (e.g., a boat or a dock). In some embodiments, coupling device 110 is used to couple the container to the rope, the cord, or other attachment to allow the user to lower the container into the water and/or pull the container out of the water. In certain embodiments, the attachment to coupling device 110 is used to control the depth to which container 102 is placed (e.g., the attachment is used to lower the container to a desired depth).

In certain embodiments, container 102 includes one or more coupling devices 110 located on or near the bottom of the container. These coupling devices 110 may be loops, hooks, or other devices for coupling one or more weights to the container. The weights may be coupled to container 102 to maintain an upright alignment of the container in the water. The weights may also aid in controlling the speed of descent of container 102 into the water. In some embodiments, the weights control and/or maintain a depth of container 102 (e.g., if the container has some buoyancy).

In certain embodiments, container 102 includes one or more rounded corners. The rounded corners may inhibit the bait fish from crowding and/or becoming trapped in comers of container 102. In certain embodiments, all inside edges of container 102 may have be at least partially rounded so that there are no 90° edges inside the container for the bait fish to experience.

Container 102 includes at least one threaded opening 112. In certain embodiments, opening 112 is located at or near the bottom of container 102. Opening 112 may accept and couple light assembly 104 to container 102, as shown in FIG. 1. Light assembly 104 may be coupled to container 102 so that the light assembly and the container form a water-tight seal. The water-tight seal inhibits water from leaking into container 102 through opening 112 when light assembly 104 is coupled to the container.

In certain embodiments, opening 112 includes riser 114, as shown in FIGS. 1 and 2. Riser 114 may have a length to accommodate the depth or thickness of light assembly 104, as shown in FIG. 1. Thus, riser 114 and light assembly 104 together may provide a relatively flat surface for container 102 to rest upon (e.g., the riser and the light assembly provide a suitable footing for the container).

In certain embodiments, light assembly 104 includes body 116, light mount 118, battery holder 120, lights 122, and cap 124, as shown in FIG. 1. FIG. 3 depicts a sectional representation of an embodiment of body 116. Body 116 may be made of lightweight, rigid materials such as plastic or acrylic. In certain embodiments, body 116 includes external threads 126. External threads 126 may couple to threads on threaded opening 112 (shown in FIG. 2) to couple body 116 to container 102 (shown in FIG. 2). Body 116 may include internal threads 128. Internal threads 128 may be used to couple cap 124 (shown in FIGS. 1, 8, and 9) to body 116. Body 116 may include one or more stops 130 for seating light mount 118 (shown in FIGS. 1, and 5-9) in the body. Body 116 may include screw or tap holes 132 for securing a lens cover to the body.

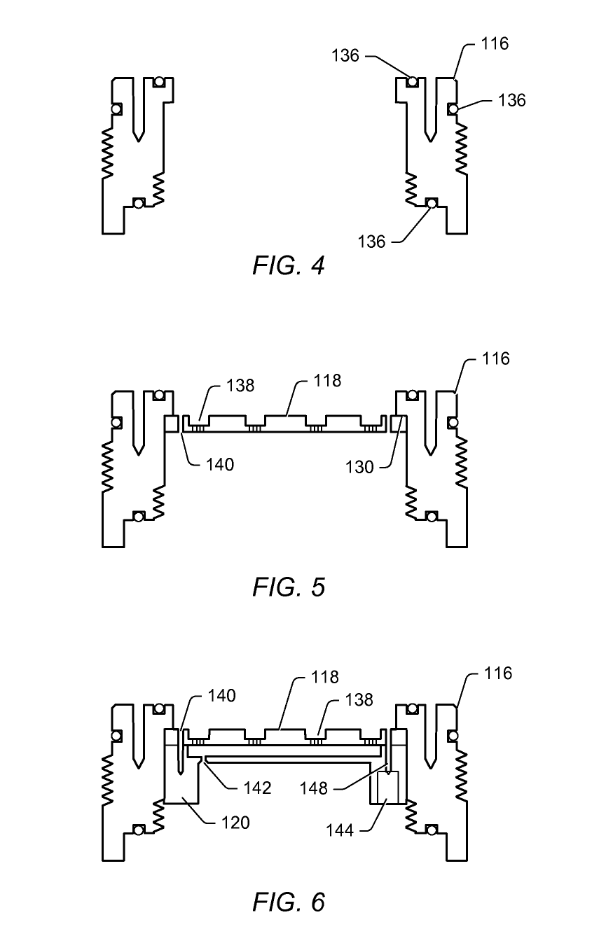

In certain embodiments, body 116 includes one or more recesses 134. Recesses 134 may allow o-rings to be seated properly on body 116. FIG. 4 depicts a sectional representation of an embodiment of body 116 with o-rings 136. O-rings 136 may be properly seated so that the o-rings are not over compressed or damaged. O-rings 136 inhibit water from leaking into critical areas of light assembly 104 (e.g., areas with water sensitive electronics). In certain embodiments, body 116 includes surface features (e.g., slots or notches) that allow a user to apply torque to the body so that the body can be properly seated in container 102 and make a water-tight seal with the container.

FIG. 5 depicts a sectional representation of an embodiment of body 116 with light mount 118 coupled to the body. Light mount 118 may be made of lightweight, rigid materials such as plastic or acrylic. Light mount 118 may have a diameter that allows the light mount to rest against stop 130 on body 116. In certain embodiments, light mount 118 is permanently attached to body 116. For example, light mount 118 may be epoxied or glued to body 116.

Light mount 118 may include one or more formed holes 138 for mounting lights to the light mount. In certain embodiments, holes 138 are uniformly spaced on light mount 118. Holes 138 may include through holes for leads to couple to lights mounted on light mount 118.

In certain embodiments, light mount 118 includes holes 140 for allowing battery holder 120 to be coupled to the light mount. FIG. 6 depicts a sectional representation of an embodiment of body 116 with light mount 118 and battery holder 120. Battery holder 120 may be made of lightweight, rigid materials such as plastic or acrylic. Battery holder 120 may have rounded edges so that the battery holder fits easily and snugly into body 116. Battery holder 120 may include one or more through holes 142 to allow battery connectors to pass through the battery holder. In certain embodiments, battery holder 120 includes a battery chamber for holding one or more AA batteries. For example, the battery chamber may hold three AA batteries. Battery holder 120 includes contact mechanisms for making electrical contact with batteries held within the battery holder.

In certain embodiments, battery holder 120 includes recess 144. In such embodiments, an on/off switch or other switch may be placed into recess 144. Battery holder 120 and light mount 118 may be shaped and coupled together so that volume 146 is located between the battery holder and the light mount. In certain embodiments, electrical connections between batteries and lights may be made in volume 146.

In certain embodiments, battery holder 120 includes holes 148. Holes 148 may be unthreaded holes. Holes 148 may mate with holes 140 on light mount 118 so that battery holder 120 can be coupled to the light mount with fasteners (e.g., self-tapping screws or the like).

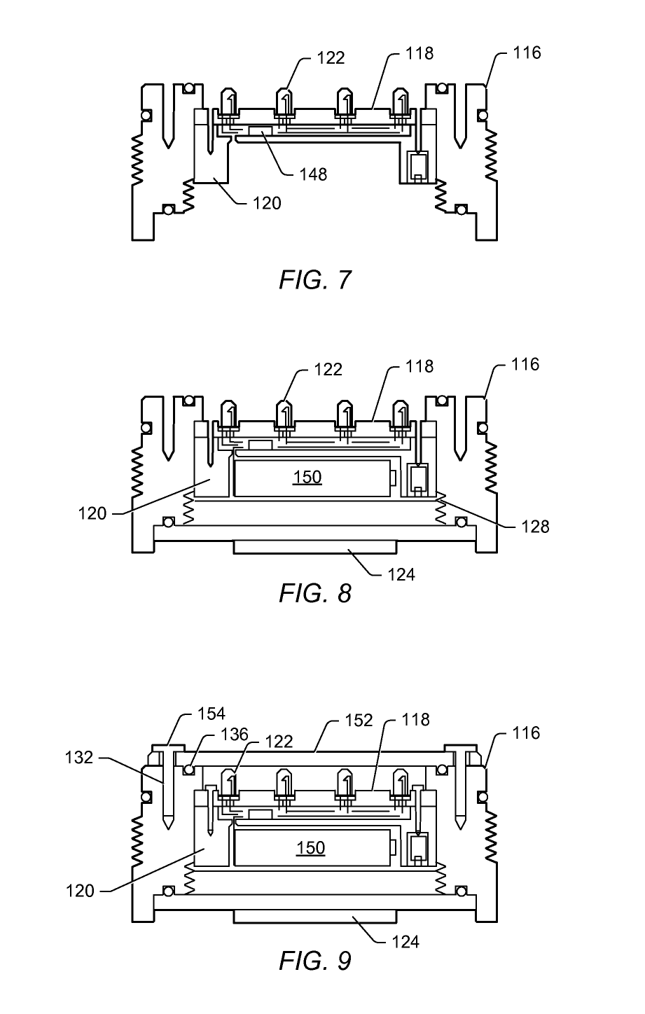

FIG. 7 depicts a sectional representation of an embodiment of body 116, light mount 118, and battery holder 120 with lights 122 coupled to the light mount. In certain embodiments, one or more light operating components 148 are coupled to lights 122. Components 148 may include, but not be limited to, resistors, diodes, switches, and battery connectors. In some embodiments, components 148 may be located on a printed circuit board.

FIG. 8 depicts a sectional representation of an embodiment of body 116, light mount 118, battery holder 120, and lights 122 with cap 124 coupled to the body. Battery 150 may be installed in battery holder 120 before coupling cap 124 to body 116. Cap 124 may include threads that mate to internal threads 128 on body 116. Cap 124 provides a water-tight seal of the battery chamber. Cap 124 may include one or more surface features (e.g., a raised bar or screwdriver slot) to allow the user to couple the cap to body 116. The raised bar or other hand operated surface feature may allow the user to couple/uncouple cap 124 to/from body 116 without the use of tools.

FIG. 9 depicts a sectional representation of an embodiment of body 116, light mount 118, battery holder 120, lights 122, and cap 124 with lens cover 152 coupled to the body. Lens cover 124 may be made of highly visible light transparent plastic, acrylic, or glass. Lens cover 124 may be coupled to body 116 using one or more fasteners 154. Fasteners 154 may be coupled to holes 132 in body 116. O-rings 136 may provide a water-tight seal between lens cover 152 and body 116.

In certain embodiments, lens cover 152 is a colored lens cover. Lens cover 152 may alter the illumination color of lights 122 so that a desired illumination color is provided in apparatus 100. In certain embodiments, the user is allowed to select the illumination color of lens cover 152 so that the desired illumination color is provided. For example, the user may remove a first lens cover with a first illumination color and replace the first lens cover with a second lens cover with a second illumination color that is different from the first illumination color.

Allowing the user to select the color of illumination in apparatus 100 provides advantages for fishing using the apparatus. Color is a significant factor in how fish (e.g., game fish) might react to live bait fish within apparatus 100. Allowing the user to change the illumination color allows the user to adapt apparatus 100 to lure different types of fish as needed. The illumination color may also be changed if a certain color proves not to be effective in luring desired fish to the apparatus. In certain embodiments, the effectiveness of live bait in apparatus 100 may be improved by illuminating the live bait with colors chosen to optimize the attractiveness of the live bait based on certain factors. The factors may include, but not be limited to, water clarity, water temperature, and time of day.

In certain embodiments, lights 122 include LEDs (light emitting diodes). Using LEDs allows for “cordless” operation of apparatus 100. Cordless operation allows for apparatus 100 to be operated without a power cable running to an external battery or other power source. Running power cables to external batteries or other power sources (e.g., a 110 voltage source) poses risks involved with power cables in a watery environment.

Apparatus 100 may be operated safely with batteries inside the apparatus using LEDs for lights 122. LEDs may be operated with batteries in the apparatus because of the low power consumption of the LEDs. The low power consumption of the LEDs allows the LEDs to be operated with small batteries (e.g., AA batteries or the like). The low power consumption of the LEDs also allows the LEDs to be battery operated for long times. For example, the LEDs may provide illumination for over 100 hours with three AA batteries. LEDs also produce low heat outputs. Having a low heat output from lights 122 reduces or eliminates temperature increases in container 102 and extends the life of the bait fish in the container.

In addition, LEDs are rugged solid state components that increase the lifetime of lights 122. LEDs are substantially resistant to physical abuse that might cause damage or failure in other light sources. Thus, apparatus 100 may be carried in boats or be subjected to other rough conditions with a lower risk for failure due to the LEDs.

In certain embodiments, lights 122 include LEDs of one or more colors. For example, the LEDs may include color-changeable or color-selectable LEDs. In certain embodiments, lights 122 include groups of LEDs of multiple colors. The illumination color in apparatus 100 may be selected by selecting which LEDs are powered on and/or at what intensity each of the powered on LEDs provide illumination. For example, an array of red, blue, and green LEDs may be able to provide numerous different color outputs depending on the relative intensities of each of the three different color LEDs.

The desired illumination color in apparatus 100 may be controlled by circuitry and/or components controlling lights 122 (e.g., the LEDs). In some embodiments, the circuitry may allow the desired illumination color to be alternated between different colors. For example, the desired illumination color may be switched between different colors on a periodic basis. The user may be allowed to select the illumination colors and the sequence, pattern, and/or timing for using each of the illumination colors. In some embodiments, the user may be allowed to remotely control lights 122 using a device that wirelessly signals the user's commands to the lights via circuitry controlling operation of the lights.

In certain embodiments, apparatus 100 includes audible stimulation devices such as, but not limited to, rattles, vibrations, or other sound making devices. The audible stimulation devices may be used to enhance the effectiveness of apparatus 100 in luring fish to the apparatus. In some embodiments, the audible stimulation devices are used to alert the user of trapped fish in apparatus 100 and/or other conditions of the apparatus. The audible stimulation devices may be located in the interior of apparatus 100 (e.g., at or near light assembly 104). In some embodiments, the audible stimulation devices are located in light assembly 104. In some embodiments, the audible stimulation devices are coupled to an exterior of apparatus 100. In some embodiments, the audible stimulation devices are coupled to circuitry and/or components used to control lights 122 so that the audible stimulation devices are controlled in cooperation with the lights.

It is to be understood that other uses of apparatus 100 may be used for illumination of other aquatic animals that may be contained within container 102. For example, aquatic animals that do not require constant aeration and filtration such as, but not limited to, frogs, turtles, goldfish, and beta fish. In addition, it may be possible to couple apparatus 100 to an aeration and/or filtration system so that aquatic animals that require such systems may be kept within the apparatus.

It is to be understood the invention is not limited to particular systems described which may, of course, vary. It is also to be understood that the terminology used herein is for the purpose of describing particular embodiments only, and is not intended to be limiting. As used in this specification, the singular forms “a”, “an” and “the” include plural referents unless the content clearly indicates otherwise. Thus, for example, reference to “a light” includes a combination of two or more lights and reference to “a fish” includes mixtures of fish.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A submersible bait apparatus, comprising:
a submersible transparent container configured to hold live fishing bait;
a light assembly coupled to the container, wherein the light assembly comprises one or more cordless, electrically powered light sources configured to provide a user selectable illumination color.

2. The apparatus of claim 1, wherein the light assembly is removably coupled to the container.

3. The apparatus of claim 1, wherein the light assembly comprises a changeable lens assembly configured to provide a desired illumination color for the light sources.

4. The apparatus of claim 1, wherein the light assembly comprises a changeable lens assembly configured to allow a user to select a desired illumination color for the light sources.

5. The apparatus of claim 1, wherein the container is configured to trap live fishing bait while submerged.

6. The apparatus of claim 1, wherein the container is configured to inhibit the live fishing bait from escaping the container.

7. The apparatus of claim 1, wherein the container comprises one or more openings that allow water into the container while inhibiting live fishing bait from escaping the container.

8. The apparatus of claim 1, further comprising a coupling device coupled to the container, wherein the coupling device is configured to couple the container to a fixed structure.

9. The apparatus of claim 1, wherein a lower portion of the container comprises a water-tight construction to inhibit water from draining from the container when the container is removed from the water.

10. The apparatus of claim 1, wherein the light sources are configured to be powered by one or more batteries located in or attached to the container.

11. The apparatus of claim 1, further comprising one or more audible stimulation devices coupled to the apparatus.

12. A submersible bait apparatus, comprising:
a submersible transparent container configured to hold live fishing bait;
one or more cordless, electrically powered light sources coupled to the container; and
a changeable lens assembly coupled to the container, wherein the lens assembly is configured to provide a desired illumination color for the light sources.

13. The apparatus of claim 12, wherein the lens assembly is removable.

14. The apparatus of claim 12, wherein the container is configured to trap live fishing bait while submerged.

15. The apparatus of claim 12, wherein the container is configured to inhibit the live fishing bait from escaping the container.

16. The apparatus of claim 12, wherein the container comprises one or more openings that allow water into the container while inhibiting live fishing bait from escaping the container.

17. The apparatus of claim 12, further comprising a coupling device coupled to the container, wherein the coupling device is configured to couple the container to a fixed structure.

18. The apparatus of claim 12, wherein a lower portion of the container comprises a water-tight construction to inhibit water from draining from the container when the container is removed from the water.

19. The apparatus of claim 12, wherein the light sources are configured to be powered by one or more batteries located in or attached to the container.

20. The apparatus of claim 12, wherein a user is allowed to change the lens assembly to provide the desired illumination color for the light sources.

21. The apparatus of claim 12, further comprising one or more audible stimulation devices coupled to the apparatus.
